(19) United States
(12) Patent Application Publication
(10) Pub. No.: US 2008/0052684 A1
(43) Pub. Date: Feb. 28, 2008

(54) Stepwise source code refactoring

(76) Inventors: Robert Bowdidge, San Jose, CA (US); David Payne, Los Altos, CA (US); Andreas Wendker, Mountain View, CA (US); Steve Naroff, San Jose, CA (US); Andrew Pontious, Mountain View, CA (US); Theodore C. Goldstein, Los Altos, CA (US)

Correspondence Address: FISH & RICHARDSON P.C., PO BOX 1022, MINNEAPOLIS, MN, 55440-1022, US

(21) Appl. No.: 11/499,886

(22) Filed: Aug. 4, 2006

(51) Int. Cl. G06F 9/45; G06F 9/44

(52) U.S. Cl. 717/136; 717/101

(57) ABSTRACT

With stepwise source code refactoring or rewriting, preconditions and resulting edits are divided into categories that can be applied to the source code after only some parsing and analysis work has been completed.

### TECHNICAL FIELD

The subject matter of this application is generally related to source code development tools.

### BACKGROUND

A refactoring transformation is a method for making controlled edits to a source code file that change a design feature of the source code without changing the code's running behavior. These changes are applied under programmer control within an editor for computer programs. The programmer identifies a transformation that is appropriate, identifies the program element in the source code that is to be changed, and the transformation performs the necessary manipulation of the source code.

The classic approach for specifying a refactoring transformation has been as a set of pre-conditions that must be met for the change to be safe and a description of how the source code or other representation of the program is changed by the transformation. The preconditions usually require analyzing the parsed representation of the program. If parsing is cheap or parsed representations are available, then these queries can be quick to perform, and a user's request for a transformation can be immediately applied.

In some situations, it may take a significant time before the preconditions can be tested and the user can be informed whether the refactoring transformation can be completed successfully. This is a particular issue for languages that are difficult to parse (e.g., C or C++), or for large programs that may take a long time to parse. In these cases, some existing products may need to parse for several minutes before giving the user any amount of feedback.

### SUMMARY

The disclosed implementations for stepwise source code refactoring or source code re-writing overcome the deficiencies of conventional solutions described above by dividing preconditions and resulting edits into one or more categories that can be applied to the source code after only some parsing and analysis work has been completed.

In some implementations, a method includes: defining one or more preconditions for a source code refactoring transformation; automatically applying the refactoring transformation to source code, including testing of at least one precondition; and providing a user with results after the at least one precondition is tested.

In some implementations, a method includes: defining one or more preconditions for source code re-writing; automatically re-writing the source code, including testing at least one precondition; and providing a user with results after the at least one precondition is tested.

In some implementations, a system includes a user interface manager and a refactoring transformation engine. The user interface manager is configured for providing a user interface for presentation on a device, and includes one or more user interface elements for receiving input specifying a refactoring transformation and source code that will be acted upon by the refactoring transformation. The refactoring transformation engine is coupled to the user interface manager and configured for refactoring the specified source code using the specified refactoring transformation, including testing for at least one precondition. The refactoring transformation engine is further configured to provide results for presentation in the user interface after the at least one precondition is tested.

Other implementations are disclosed that are related to apparatuses, systems, methods and computer-readable mediums.

With stepwise source code refactoring, a user does not have to wait until all parsing and analysis work is complete before receiving results. By immediately receiving results, the user can start examining changes proposed by the transformation to validate that the transformation is what the user intended and that the changes are safe and correct. Thus, stepwise source code refactoring improves the user experience for refactoring and speeds the process of refactoring.

The details of one or more of the disclosed implementations of stepwise source code refactoring or re-writing are set forth in the accompanying drawings and the description below. Other features, objects, and advantages will be apparent from the description and drawings, and from the claims.

### DESCRIPTION OF DRAWINGS

FIG. 1 is an example of a user interface for editing source code.

FIG. 2 is an example of a user interface for refactoring source code showing a first refactoring transformation.

FIG. 3 is an example of a user interface for refactoring source code showing a second refactoring transformation.

FIG. 4 is an example of a user interface for refactoring source code showing a list of files in a source code module.

FIG. 5 is an example of a user interface for refactoring source code showing a critical error.

FIG. 6 is an example of a user interface for refactoring source code showing a refactoring transformation preview in progress.

FIG. 7 is an example of a user interface for refactoring source code showing a preview of differences between a source code file before a refactoring transformation and after the refactoring transformation.

FIG. 8 is an example of a user interface for refactoring source code showing a completed refactoring transformation preview.

FIG. 9 is a schematic diagram showing an example of a source code module that has undergone a stepwise refactoring transformation.

FIG. 10 is a flow chart showing an example of a process for performing a stepwise refactoring transformation.

FIG. 11 is a block diagram showing an example of a system for performing a stepwise refactoring transformation.

Like reference symbols in the various drawings indicate like elements.

### DETAILED DESCRIPTION

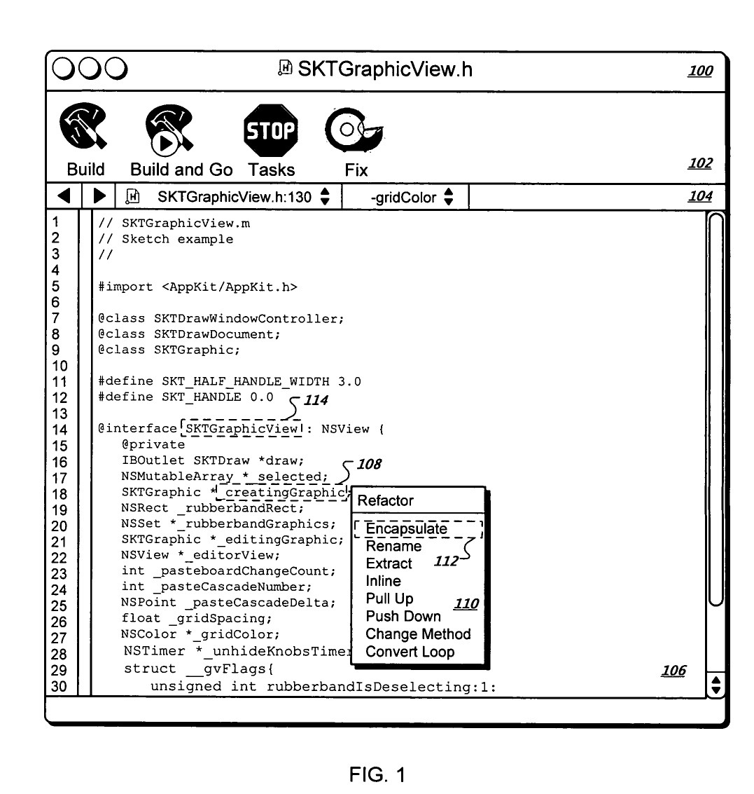

FIG. 1 is an example of a user interface (UI) 100 for editing source code. The source code editor UI 100 includes a button toolbar 102, a menu bar 104, and a source code presentation area 106. Here, in the code presentation area 106, the source code editor UI 100 presents an “SKTGraphView.h” source code file. The “SKTGraphView.h” file includes source code written using the Objective C programming language. Alternatively, the source code editor 100 may present source code using other programming languages, such as Java or C++. A user may select an identifier, for example, to undergo a refactoring transformation, as represented by dashed line 108. Source code refactoring transformations are well known and generally are processes for rewriting source code to improve its structure or readability, while preserving its meaning or behavior. While the methods and systems described herein relate to refactoring transformations, other source code transformations may be performed as well.

A user may open a menu 110 of refactoring transformations, for example, by right-clicking on the selected identifier. The menu 110 includes a list of refactoring transformations from which a user may make a selection. In certain implementations, the list includes only the refactoring transformations relevant to the selected identifier or makes refactoring transformations that are not relevant non-selectable. Alternatively, a user may initiate a refactoring transformation by other means, such as by making a selection in the toolbar 102 or the menu bar 104.

Here, the user makes an “Encapsulate” selection, as indicated by dashed line 112. Encapsulation refers to hiding access to a variable using “getter” and “setter” methods or functions. The encapsulate refactoring transformation replaces instances of the variable in the source code with the “setter” function where an assignment is made to the variable and the “getter” function where the variable is used as an operand.

Alternatively, a user may select an “SKTGraphicView” identifier to undergo a refactoring transformation, as indicated by dashed line 114. The user may initiate a different refactoring transformation on the “SKTGraphicView” identifier, such as a renaming of the identifier.

In addition, other refactoring transformations may be performed. For example, one or more members of a class may be extracted and used to create a new super-class above the original class and below a parent of the original class. A class may be merged or inlined with another class. One or more members of a class may be pulled up from the original class to a parent class of the original class or pushed down to a child class of the original class. A method signature may be changed by adding, removing, or reordering parameters of the method. Language specific refactoring transformations may be performed, such as by converting a statement that loops through elements of an array to a particular loop syntax provided by the programming language.

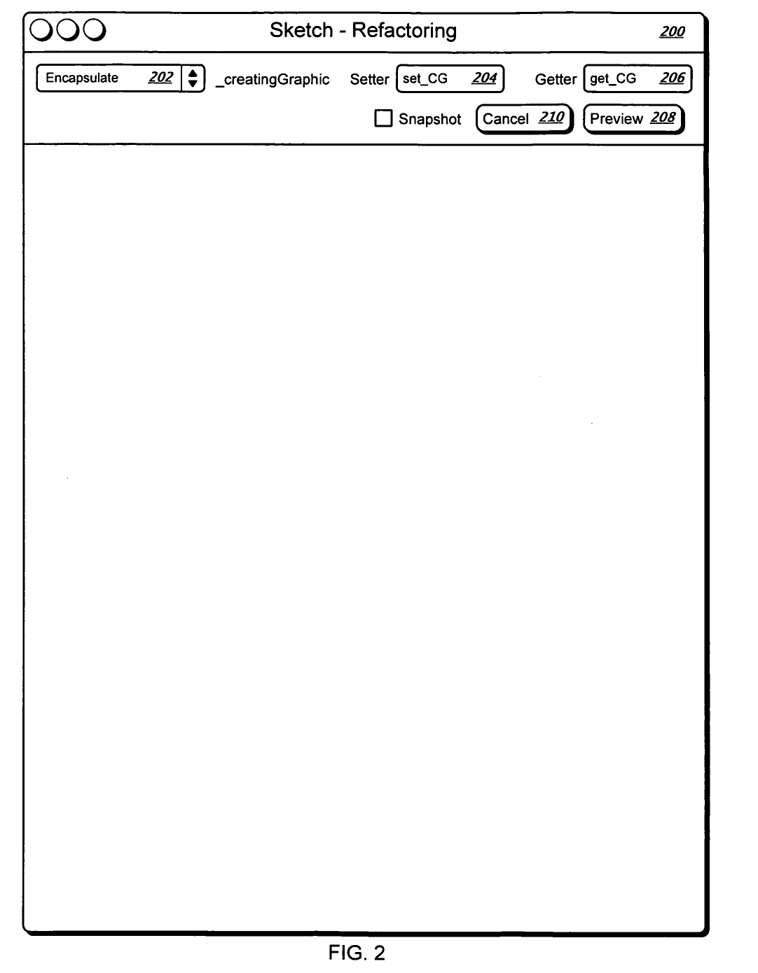

FIG. 2 is an example of a user interface 200 for refactoring source code showing a first refactoring transformation. A user may initiate the refactoring UI 200 by making a selection in the refactoring menu 110, such as the selection of the encapsulation refactoring transformation. The refactoring UI 200 includes a selection control 202 that allows a user to select a refactoring transformation to be performed. Here, the control 202 shows the “Encapsulate” refactoring transformation that the user selected in the menu 110. The refactoring UI 200 also includes input controls 204 and 206 that allow a user to make inputs for a setter function name and a getter function name, respectively. In certain implementations, setter and getter function names may be automatically generated, such as by concatenating “set” or “get” with the variable name or an abbreviation of the variable name. A user may initiate a preview of edits to be made to the source code as a result of the refactoring transformation by selecting a preview button 208. A user may cancel the generation of the preview by selecting a cancel button 210. In general, the controls made available to a user within the refactoring UI 200 vary depending on the refactoring transformation selected in the control 202.

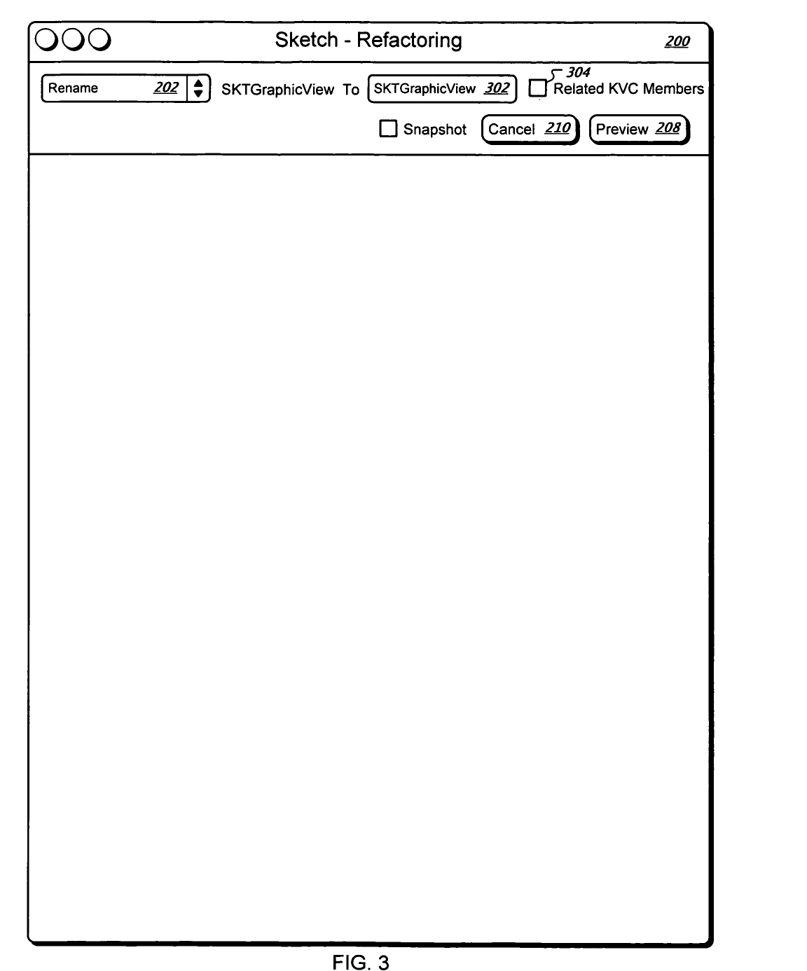

FIG. 3 is an example of the user interface 200 for refactoring source code showing a second refactoring transformation. Here, the selection control 202 shows a “Rename” refactoring transformation to be performed on the “SKTGraphicView” identifier. The refactoring UI 200 now includes an input control 302 that allows a user to input a new name for the identifier to be renamed. The refactoring 200 also includes a selection control 304 that allows a user to select whether or not related key-value coding (KVC) members should be renamed as well. For example, there may exist other identifiers, such as variables or properties, in the source code that are related to the “SKTGraphicView” identifier. These related KVC members may be referred to using an identifier other than the actual identifiers of the variables or properties. The identifiers of related KVC members, or portions of the identifiers, may be renamed along with the selected identifier by activating the selection control 304. After inputting a new identifier in the control 302, a user may initiate a preview of the renaming refactoring transformation by selecting the preview button 208.

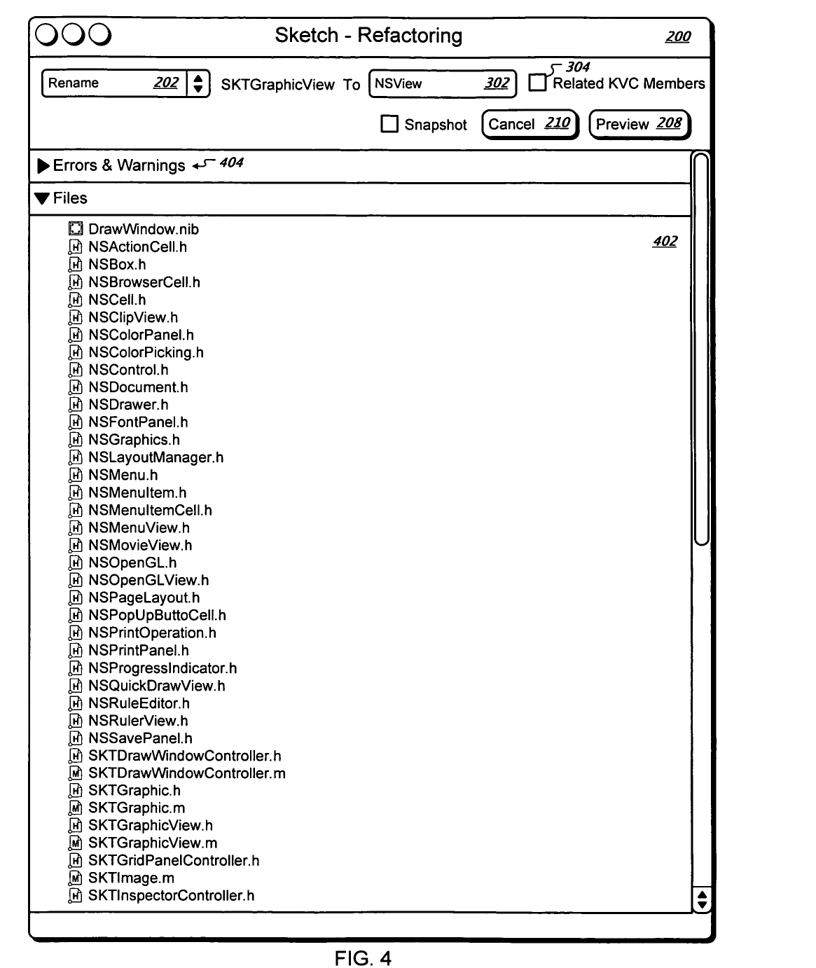

FIG. 4 is an example of the user interface 200 for refactoring source code showing a list 402 of files in a source code module. A source code module may be, for example, a collection of source code files that compose an application, library, applet, servlet, script, or some combination thereof. In this example, the “SKTGraphicView” identifier is used in a code module named “Sketch.” The list 402 includes the source code files that compose the code module “Sketch.” Here, a user has made an input in the control 302 indicating a new identifier, “NSView,” for the “SKTGraphicView” identifier. After selecting the preview button 208, a user may view non-critical errors and warning by selecting an errors and warnings control 404. The refactoring UI 200 presents critical errors (e.g., errors that block the processing of the refactoring transformation) in a separate window or dialog.

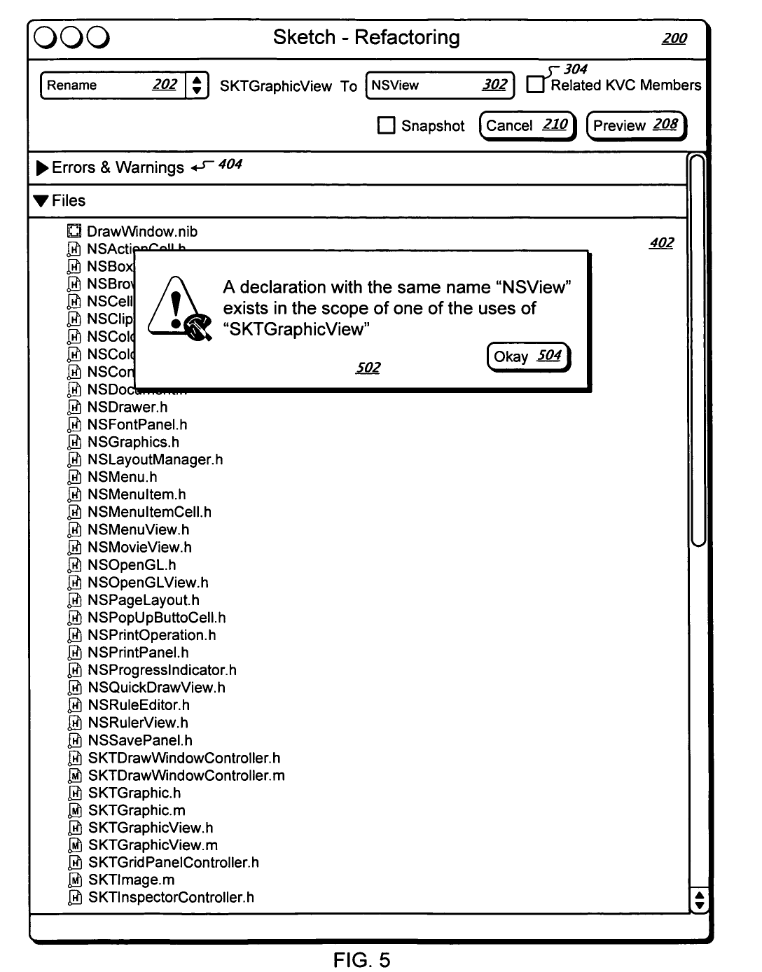

FIG. 5 is an example of the user interface 200 for refactoring source code showing a critical error. The error is presenting in a separate window 502. In general, critical errors prevent the refactoring transformation from being performed. For example, the error shown in the window 502 may be the result of testing a precondition for the rename refactoring transformation. The error indicates that the “NSView” identifier is already in use and therefore may not be used to rename the “SKTGraphicView” identifier. This precondition is tested before the source code in the source code files is parsed or edited. Other preconditions may be tested before parsing a particular source code file, before each source code file, or after all source code files have been parsed and/or edited. A user may close the window 502 by selecting an okay button 504 and then input another new identifier using the input control 302.

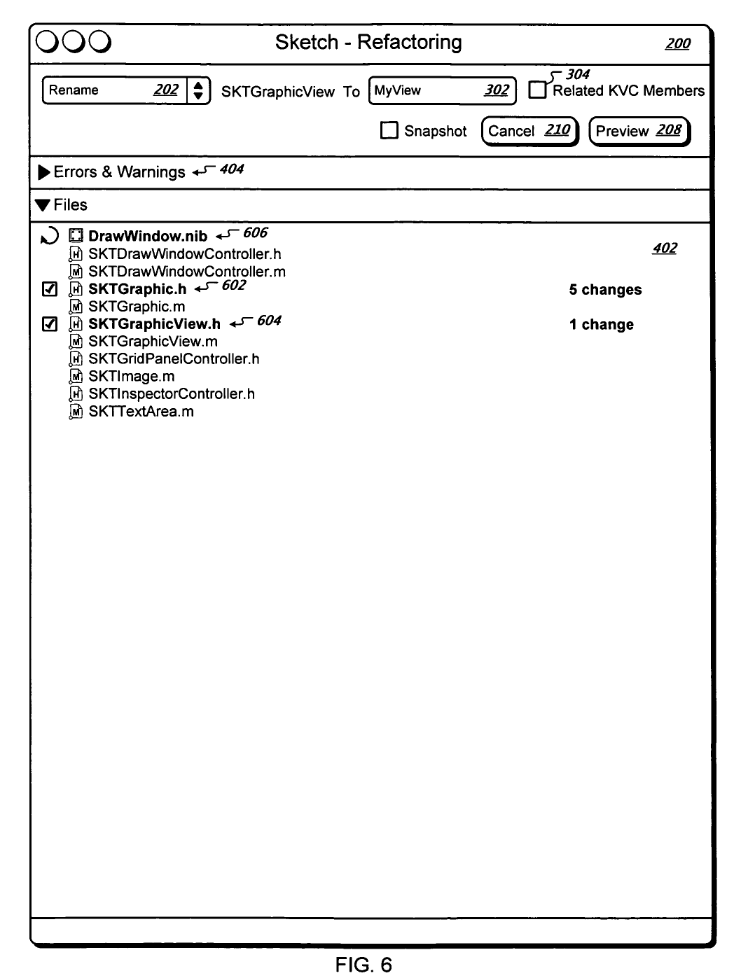

FIG. 6 is an example of the user interface 200 for refactoring source code showing a refactoring transformation preview in progress. Here, a user has made an input, “MyView,” using the input control 302 and has again selected the preview button 208. The file list 402 now presents those source code files that contain the identifier “SKTGraphicView.” In certain implementations, the file list 402 is determined using a search of previously indexed identifiers that occur in the source code files. The refactoring transformation preview process tests preconditions, parses, and edits these source code files individually. In certain implementations, a user may change the order in which the refactoring transformation processes the list 402. For example, a user may drag and drop one or more of the files to a new location in the list 402. The refactoring UI 200 indicates the results of the refactoring transformation preview as each file is edited.

For example, parsing and editing is complete for files 602 and 604 as indicated by their boldface font and the indication of the number of changes made as a result of the refactoring transformation. In addition, the files 602 and 604 have associated selection controls. The selection controls allow a user to select whether or not the refactoring transformation process will permanently apply the changes in the preview to the associated file. The refactoring transformation process is currently in progress for a file 606 as indicated by its boldface font and its lack of a change count. A spinning animation associated with the file 606 also indicates that the parsing and editing of the file 606 are in progress. After the refactoring transformation process is complete for a particular source code file, a user may review and analyze the edits made to the source code file. This may occur while the refactoring transformation process continues on another source code file in the source code module. That is, the refactoring transformation is performed in a stepwise fashion to allow a user to analyze and review edits resulting from portions of the refactoring transformation while the refactoring transformation is still in progress on other portions of the code module.

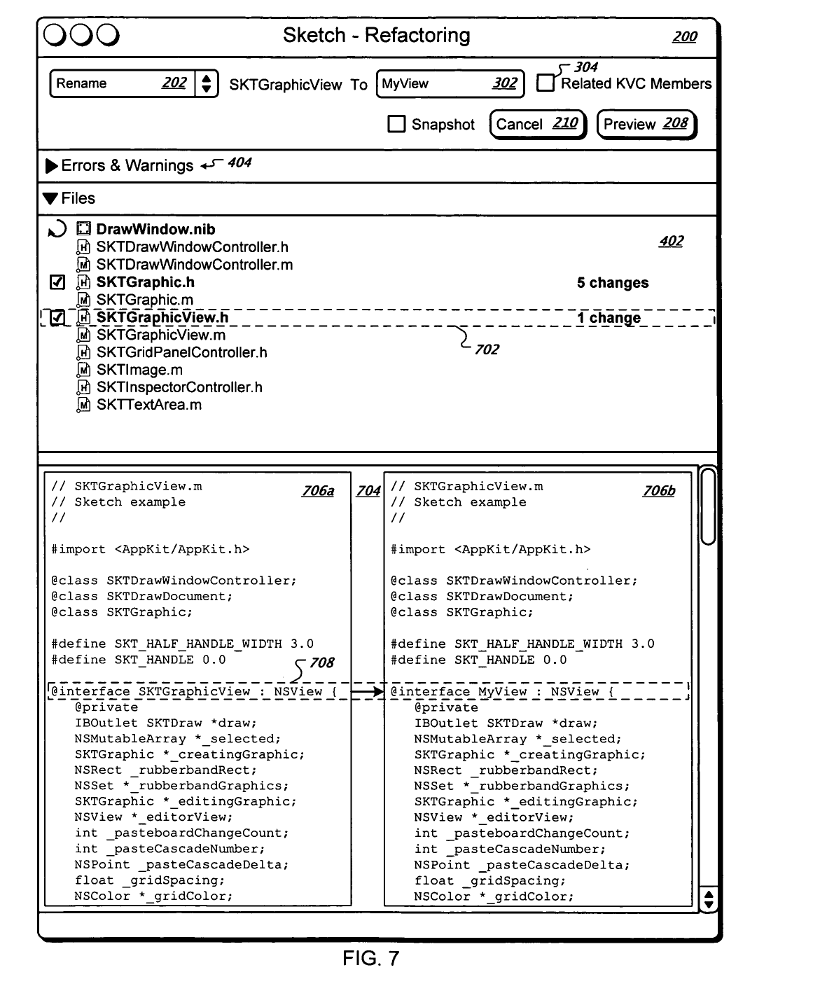

FIG. 7 is an example of the user interface 200 for refactoring source code showing a preview of differences between a source code file before a refactoring transformation and the source code file after the refactoring transformation. Here, a user has selected a source code file in the file list 402, as indicated by dashed line 702.

The refactoring UI 200 presents a preview area 704 that includes a pre-refactoring transformation representation 706 of the selected source code file and a post-refactoring transformation representation 708 of the source code file. In addition, the preview area 704 indicates one or more individual edits using highlighting, as represented by dashed line 710. A user may review the edits and make changes to the edits as the refactoring transformation continues on one or more other source code files.

If one or more preconditions associated with the edit shown here generate non-critical errors and/or warnings, then a user may review the errors and/or warnings by selecting the errors and warnings control 404. A user may review errors and warnings while the refactoring transformation is in progress. In certain implementations, a user may select an error or warning, while reviewing the errors and warnings list, to present an associated source code file and its edits in the preview area 704.

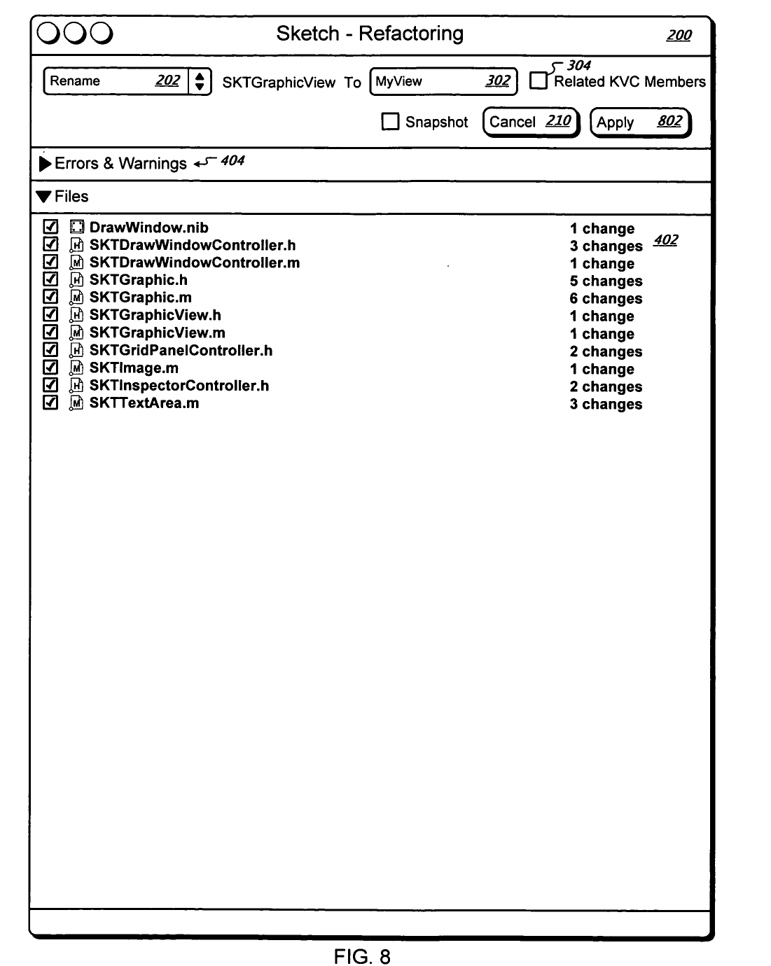

FIG. 8 is an example of the user interface 200 for refactoring source code showing a completed refactoring transformation preview. The preview button 208 is now replaced with an apply button 802. The apply button 802 allows a user to permanently apply the previewed edits to the source code files. In certain implementations, the refactoring transformation process makes one or more final precondition tests and their associated final edits when a user selects the apply button 802.

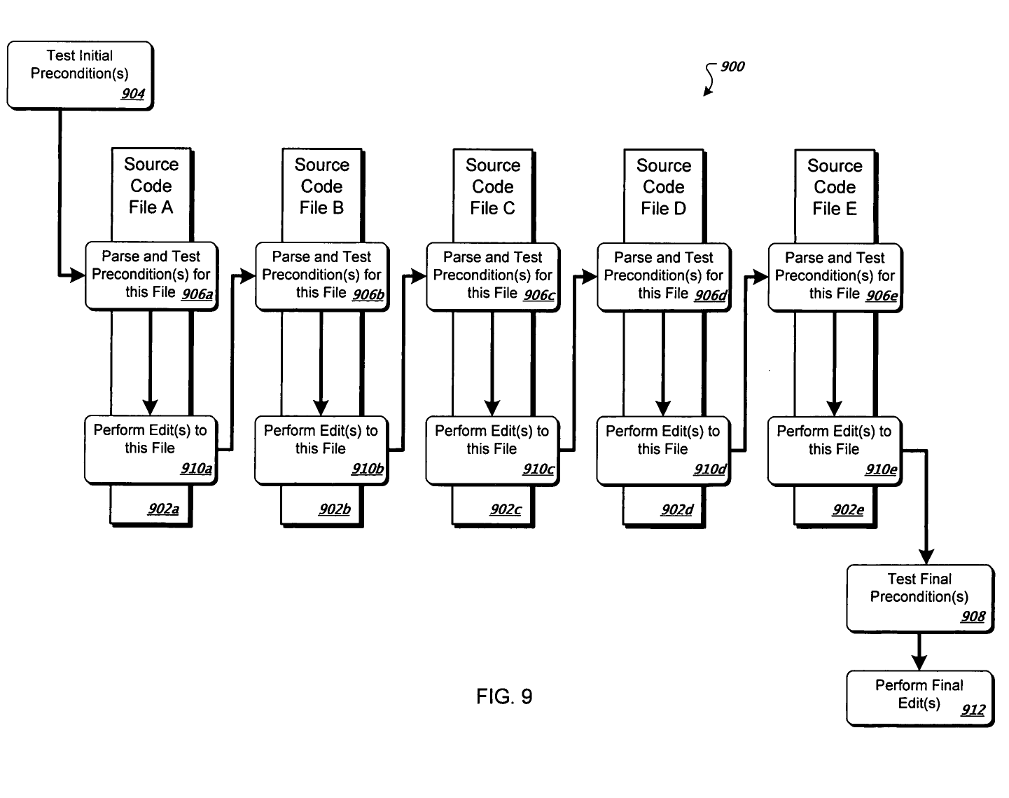

FIG. 9 is a schematic diagram showing an example of a code module 900 that has undergone a stepwise refactoring transformation. The code module 900 includes source code files 902a-e. The refactoring transformation process begins by testing (904) one or more initial preconditions. For example, after a user selects the preview button 208, the rename refactoring transformation process tests the new “NSView” identifier to determine if it is a valid identifier (e.g., testing the identifier to determine if it is already in use as an identifier or a keyword reserved by the programming language, testing the identifier to determine if the identifier contains invalid characters, such as an operator symbol or a comment symbol). This is an initial precondition, that is, the refactoring transformation process can test this precondition before parsing any of the source code files 902a-e. A second category of preconditions can be tested after parsing one or more of the source code files. For example, where the source code file 902a includes a declaration of the “SKTGraphicView” identifier, such as the “SKTGraphicView.h” file, the refactoring transformation process may determine (906a) the type of the element to be renamed and whether the determined type is acceptable for renaming. In a third category of preconditions, the refactoring transformation process may test each of the files 902a-e after they are parsed. For example, the refactoring transformation process may determine (906a-e) that one or more of the source code files 902a-e include a local variable having an identifier that is the same as the new identifier used for the renaming. The refactoring transformation process performs these tests (906a-e) after parsing each the source code files 902a-e, respectively. In a fourth and final category of preconditions, the refactoring transformation process tests preconditions after parsing, testing, and editing all of the source code files 902a-e. For example, the refactoring transformation process may determine (908) if a declaration of the element represented by the renamed identifier was found. If not, then the refactoring transformation process may present an error or warning indicating that the rename refactoring transformation may be incomplete.

In certain implementations, an edit category contains instructions to manipulate representations of the program other than the text representation of the source code. For example, if the program is stored internally in the editor as a parse tree, the edit category may describe the changes in terms of changes to the parse tree. If the editor is maintaining additional data structures such as dataflow graphs, then the edit category can specify how the dataflow graph is changed by the transformation.

In certain implementations, a method other than the previously described four categories may be used to define the precondition categories. Particularly, in programming environments without a “file” concept this is the case. For example, precondition categories may be divided according to functionality, such as on a class and/or function basis, or at a higher conceptual level than the class/function level, such as by user interface management, database access, and internal processing. In general, the precondition categories divide the testing of the preconditions into groups that may be performed in a stepwise fashion. This allows a user to review and analyze results of one or more precondition tests as one or more other precondition tests are performed.

Edits performed by the refactoring transformation are also organized into categories. In this example, there are two edit categories, that is, edits that can be performed after parsing and testing a file and edits that can be performed after parsing and testing all of the source code files 902a-e. For example, the refactoring transformation process may edit (910a-e) each of the source code files 902a-e to rename the “SKTGraphicView” identifier to “MyView.” After parsing, testing, and editing each of the files 902a-e individually and performing the final test (908), the refactoring transformation process may perform a final edit. For example, when an encapsulation refactoring transformation process is performed, a location for the setter and getter functions may be determined after all uses of the encapsulated variable have been determined. If the variable is only used in one source code file, then the setter and getter functions may be placed (912) in that source code file. Otherwise, if the variable is accessed in multiple source code files, then the setter and getter functions may be placed (912) in a file accessible by the source code files and declarations of the functions may be placed (912) in a file included by the source code files, such as a header file.

In certain implementations, a method other than the previously described two categories may be used to define the edit categories, such as the alternatives previously described for precondition categories. In addition, one or more edit categories may be added, such as an edit category (or precondition category) for refactoring transformations to be made to another code module as a result of the refactoring transformation to the current code module. For example, the renamed “SKTGraphicView” identifier may be used in a code module other than the “Sketch” code module. In general, the edit categories divide the editing of source code files in a code module into groups that may be performed in a stepwise fashion. This allows a user to review and analyze results of one or more edits as one or more other edits are performed.

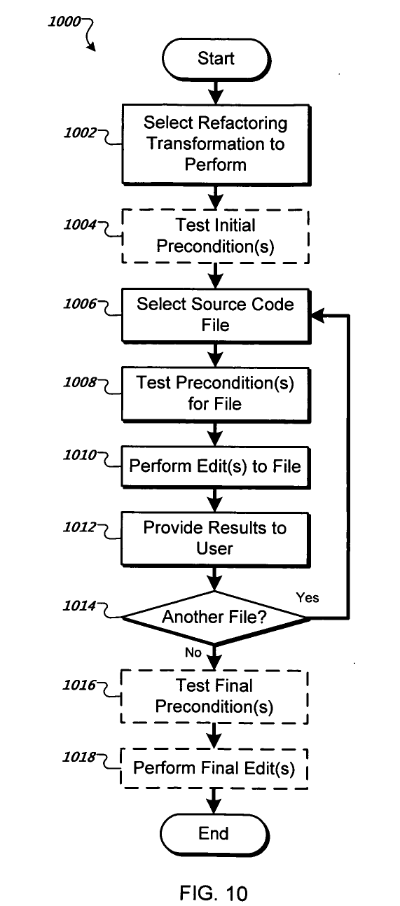

FIG. 10 is a flow chart showing an example of a process 1000 for performing a stepwise refactoring transformation. The process 1000 begins with selecting (1002) a refactoring transformation to perform. For example, the process 1000 may receive a user input, such as the selections 108 and 112, indicating an encapsulation refactoring transformation to be performed on the “_creatingGraphic” identifier.

Optionally, the process 1000 may test (1004) one or more initial preconditions. For example, the renaming refactoring transformation process may test (904) an initial precondition that verifies “MyView” as a valid identifier.

The process 1000 selects (1006) a source code file. For example, a user may indicate, via the refactoring UI 200, a particular order for processing the source code files by dragging and dropping the files in the list 402. The process 1000 may proceed sequentially through the list 402 of source code files.

The process 1000 tests (1008) one or more preconditions for the selected source code file. For example, the renaming refactoring transformation process may perform tests to determine the type of the “SKTGraphicView” identifier, whether the type may be renamed, and whether a local variable in the selected source code file already uses the new “MyView” identifier.

The process 1000 performs (1010) edits to the selected source code file. For example, the renaming refactoring transformation process may rename each instance of the “SKTGraphicView” identifier as the “MyView” identifier.

The process 1000 provides (1012) results to a user. For example, the refactoring UI 200 indicates, in the list 402, completed processing using boldface font, a selection control, and an indication of the number of changes. The refactoring UI 200 also indicates a refactoring transformation in progress using boldface font and a spinning animation. In addition, the refactoring UI 200 may present further results in the preview area 704, such as changes due to edits, or errors and warnings may be presented to a user in an error and warning list.

If there is another file to transform (1014), then the process 1000 selects (1008) another source code file. Optionally, if there are no more source code files to transform, then the process 1000 may test (1016) one or more final preconditions. For example, the renaming refactoring transformation process may perform a test to determine if a declaration of the “SKTGraphicView” was replaced. If not, the renaming refactoring transformation process may record an error or warning indicating that the refactoring may be incomplete.

Optionally, the process 1000 may perform one or more final edits to a source code module after making individual edits to the source code files. For example, the encapsulation refactoring transformation may determine a location for setter and getter functions, such as a source code file where accesses to an encapsulated variable occur or a library accessible by multiple source code files that access the encapsulated variable.

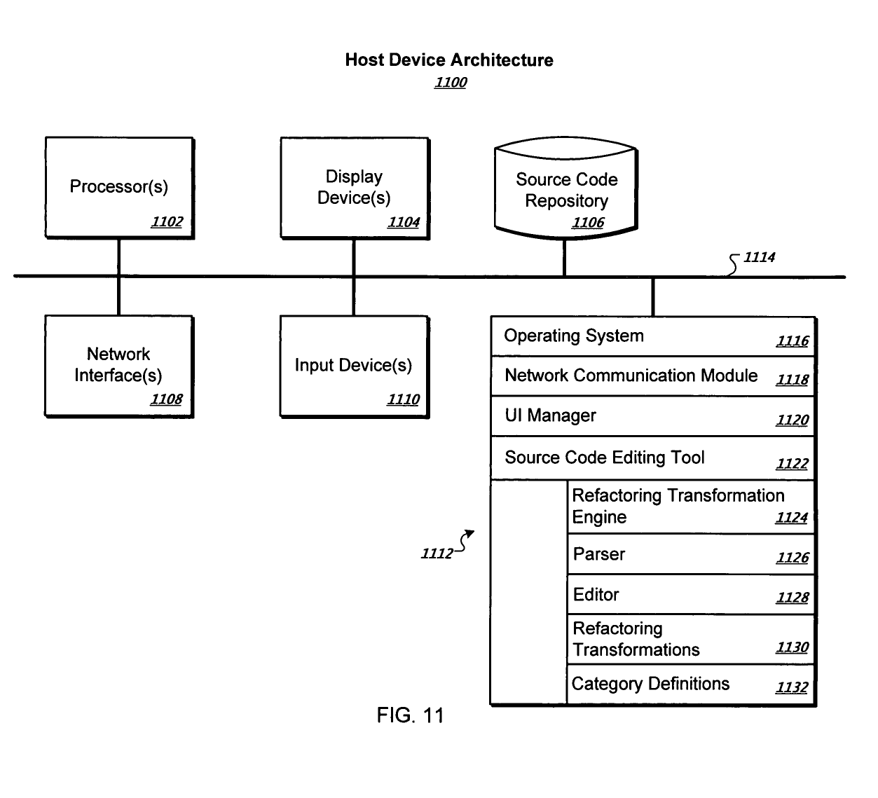

FIG. 11 is a block diagram of an exemplary host device architecture 1100 for hosting a stepwise source code refactoring process, as described in reference to FIGS. 1-10. Other architectures are possible, including architectures with more or fewer components.

In some implementations, the host device architecture 1100 includes one or more processors 1102 (e.g., dual-core Intel® Xeon® Processors), a display device 1104 (e.g., an LCD), a source code repository 1106, a network interface 1108 (e.g., a Ethernet, USB, Firewire®), one or more input devices 1110 (e.g., mouse, keyboard) and one or more computer-readable mediums 1112 (e.g., RAM, ROM, SDRAM, hard disk, optical disk, flash memory, SAN, etc.).

The components of the host device architecture 1100 described above can exchange communications and data over one or more buses 1114 (e.g., EISA/ISA, PCI, PCI-Express) for facilitating the transfer of data and control signals between the component of the architecture 1100.

The term “computer-readable medium” refers to any medium that participates in providing instructions to a processor 1102 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 1112 further includes an operating system 1116 (e.g., Mac OS®, Windows® XP, Linux® OS), a network communication module 1118, a UI manager 1120, and a source code editing tool 1122. The operating system 1116 can be multi-user, multiprocessing, multitasking, multithreading, real time, etc. The operating system 1116 performs basic tasks, including but not limited to: recognizing input from the input devices 1108 and providing output to the display device 1104; keeping track and managing files and directories on computer-readable mediums 1112 (e.g., memory or a storage device); controlling peripheral devices (e.g., printers, external storage devices); and managing traffic on the one or more buses 1114. The network communications module 1118 includes various components for establishing and maintaining network connections and services (e.g., software for implementing communication protocols and services, such as TCP/IP, HTTP, sync services, etc.). The UI manager 1120 includes various software components for displaying and managing windows and related processes.

The source code editing tool 1122 further includes a refactoring transformation engine 1124, a parser 1126, an editor 1128, refactoring transforms 1130 and category definitions. These components provide the various processes and features described in reference to FIGS. 1-10 and can be written in any known computer language (e.g., written in Objective-C).

A number of implementations of stepwise source code refactoring or re-writing have been described. Nevertheless, it will be understood that various modifications may be made to the disclosed implementations without departing from the spirit and scope of the invention. Accordingly, other implementations are within the scope of the following claims.

What is claimed is:

1. A method, comprising:
defining one or more preconditions for a source code refactoring transformation;
automatically applying the refactoring transformation to source code, including testing of at least one precondition; and
providing a user with results after the at least one precondition is tested.

2. The method of claim 1, further comprising:
defining a category of preconditions; and
providing a user with results after at least some of the preconditions in the category are tested.

3. The method of claim 2, further comprising:
defining the category to include preconditions to be tested prior to parsing of the source code.

4. The method of claim 2, further comprising:
defining the category to include preconditions to be tested after a file containing the source code is parsed.

5. The method of claim 2, further comprising:
defining the category to include preconditions to be tested after parsing is complete.

6. The method of claim 1, further comprising:
defining a category of edits; and
providing a user with results after the category of edits is performed.

7. The method of claim 6, further comprising:
defining the category to include edits to perform after a file containing the source code is parsed.

8. The method of claim 6, further comprising:
defining the category to include edits to perform after all parsing is complete.

9. The method of claim 1, where providing results further comprises:
providing the user with a list of errors.

10. The method of claim 1, where providing results further comprises:
providing the user with a warning.

11. The method of claim 1, further comprising:
providing the user with visual feedback relating to the progress of the refactoring transformation.

12. The method of claim 1, further comprising:
providing the user with a list of source code files to be transformed;
providing the user with a control mechanism for allowing the user to modify the order in which the source code files are to be transformed;
receiving input from the user specifying a new order; and
responsive to the input, modifying the order in which the source code files are to be transformed in accordance with the input.

13. The method of claim 1, further comprising:
providing the user with a display including a first portion and a second portion, where the first portion is configured for displaying source code prior to applying the refactoring transformation and the second portion is configured for displaying refactored source code.

14. The method of claim 1, further comprising:
providing a set of identifiers for identifying particular source code files out of a plurality of source code files for parsing.

15. A method, comprising:
defining one or more preconditions for source code re-writing;
automatically re-writing the source code, including testing at least one precondition; and
providing a user with results after the at least one precondition is tested.

16. A system, comprising:
a user interface manager configured for providing a user interface for presentation on a device, the user interface including one or more user interface elements for receiving input specifying a refactoring transformation and source code that will be acted upon by the refactoring transformation; and
a refactoring transformation engine coupled to the user interface manager and configured for refactoring the specified source code using the specified refactoring transformation, including testing for at least one precondition, the refactoring transformation engine further configured to provide results for presentation in the user interface after the at least one precondition is tested.

17. A computer-readable medium having instructions stored thereon, which, when executed by a processor, causes the processor to perform the operations of:
defining one or more categories of one or more preconditions for a source code refactoring transformation;
automatically applying the refactoring transformation to source code, including testing of at least one precondition in at least one category; and
providing a user with results after the at least one precondition is tested.

18. The computer-readable medium of claim 17, further comprising:
defining a category of edits; and
providing a user with results after the category of edits is performed.

19. The computer-readable medium of claim 17, further comprising:
providing the user with visual feedback relating to the progress of the refactoring transformation.

20. A system, comprising:
means for defining one or more categories of one or more preconditions for a source code refactoring transformation;
means for automatically applying the refactoring transformation to source code, including testing of at least one precondition in at least one category; and
means for providing a user with results after the at least one precondition is tested.
